(19) United States
(12) Patent Application Publication
(10) Pub. No.: US 2014/0146463 A1
(43) Pub. Date: May 29, 2014

(54) HARD DISK DRIVE MODULE

(71) Applicant: HON HAI PRECISION INDUSTRY CO., LTD., New Taipei (TW)

(72) Inventors: PO-CHUAN HSIEH, New Taipei (TW); EN-SHUO CHANG, New Taipei (TW)

(73) Assignee: HON HAI PRECISION INDUSTRY CO., LTD., New Taipei (TW)

(21) Appl. No.: 13/705,198

(22) Filed: Dec. 5, 2012

(30) Foreign Application Priority Data
Nov. 29, 2012 (TW) 101144761

(51) Int. Cl. G11B 33/02; G06F 1/16

(52) U.S. Cl. CPC G11B 33/022; G06F 1/16
USPC 361/679.33

(57) ABSTRACT

A hard disk drive module includes a bracket, a hard disk drive received in the bracket, and a shielding member. A bar code is mounted on the hard disk drive. The bracket includes a main body defining an opening. The shielding member is made of electromagnetic interference shielding material and received in the opening. The shielding member defines a through slot through which the bar code is exposed.

### BACKGROUND

1. Technical Field

The present disclosure relates to a hard disk drive module.

2. Description of Related Art

Hard disk drives are important data storage apparatus used in devices such as servers, data centers, and other types of computer systems. Such devices may be equipped with a plurality of hard disk drives, and a bar code affixed on each hard disk drive for identifying and/or inventorying each drive using a bar code scanner. However, it is difficult to predict exactly how hard drives will be oriented in different environments, with the result that in many applications the bar codes may not be positioned where they can be easily scanned, requiring removal of the drives when scanning is required.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a hard disk drive module, wherein the hard disk drive module includes a shield member.

FIG. 2 is an enlarged view of the shield member of FIG. 1, but viewed from another perspective.

FIG. 3 is an assembled, isometric view of FIG. 1, but viewed from another perspective.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

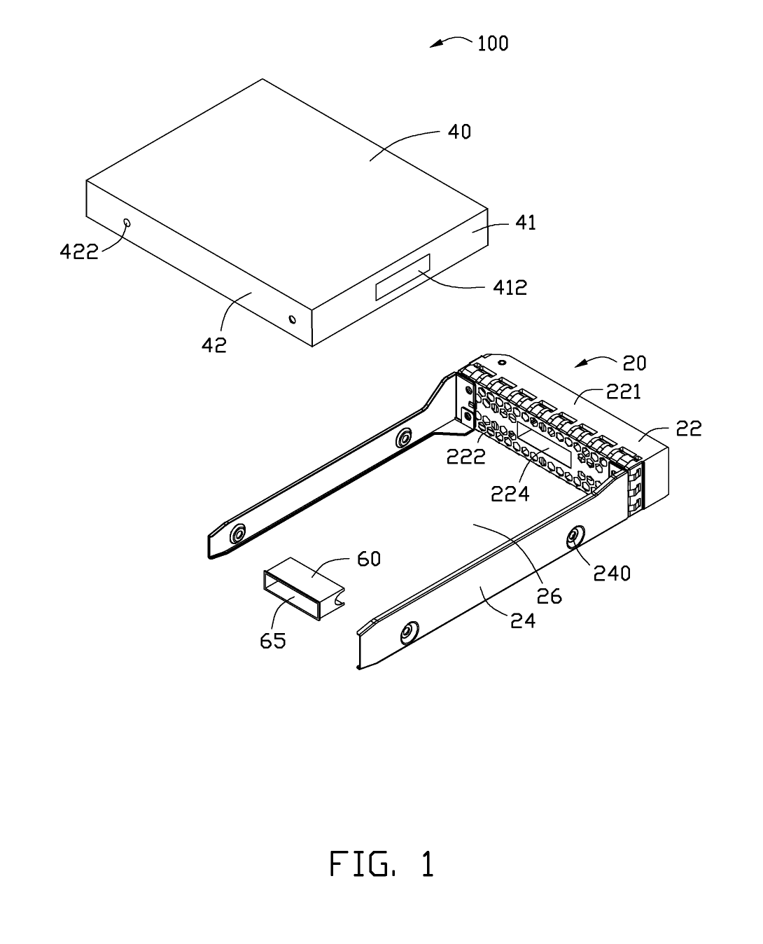

Referring to FIG. 1, an exemplary embodiment of a hard disk drive module 100 is adapted for an electronic device, such as a server or other type of computer. The hard disk drive module 100 includes a bracket 20, a hard disk drive 40, and a shield member 60.

The bracket 20 is substantially U-shaped, and includes a main body 22 and two arms 24 respectively extending rearward from two opposite ends of the main body 22 in a substantially perpendicular manner. The main body 22 and the arms 24 cooperatively bound a receiving space 26 for receiving the hard disk drive 40. Each arm 24 defines a plurality of through holes 240. The main body 22 includes a front wall 221 and a shield plate 222 sandwiched between the front wall 221 and the arms 24. The shield plate 222 is made of electromagnetic interference shielding material, such as steel, copper, or aluminum. The front wall 221 defines a rectangular opening 224 extending through the shield plate 222.

The hard disk drive 40 includes a front end surface 41 and two opposite side surfaces 42. A bar code 412 is mounted on the front end surface 41. Each side surface 42 defines a plurality of screw holes 422.

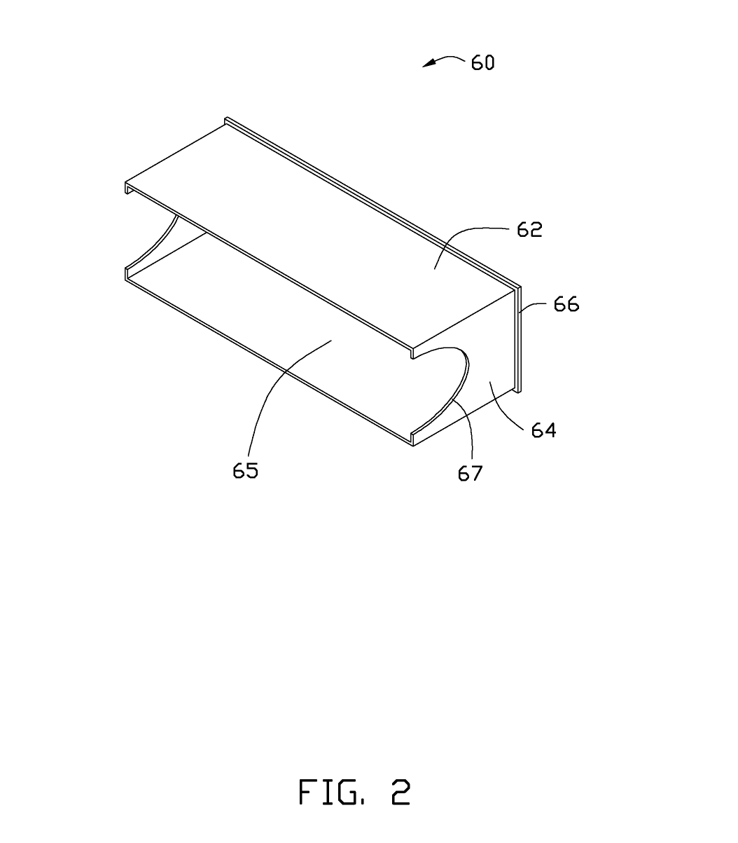

Referring to FIG. 2, the shield member 60 is a substantially rectangular shell, and is made of electromagnetic interference shielding material, such as steel, copper, or aluminum. The shield member 60 includes two opposite side plates 62, and two opposite end plates 64 connected between corresponding ends of the side plates 62. The side plates 62 and the end plates 64 cooperatively bound a through slot 65. A front side of each end plate 64 defines an arc-shaped cutout 67. A flange 66 protrudes out from rear sides of the side plates 62 and the end plates 64.

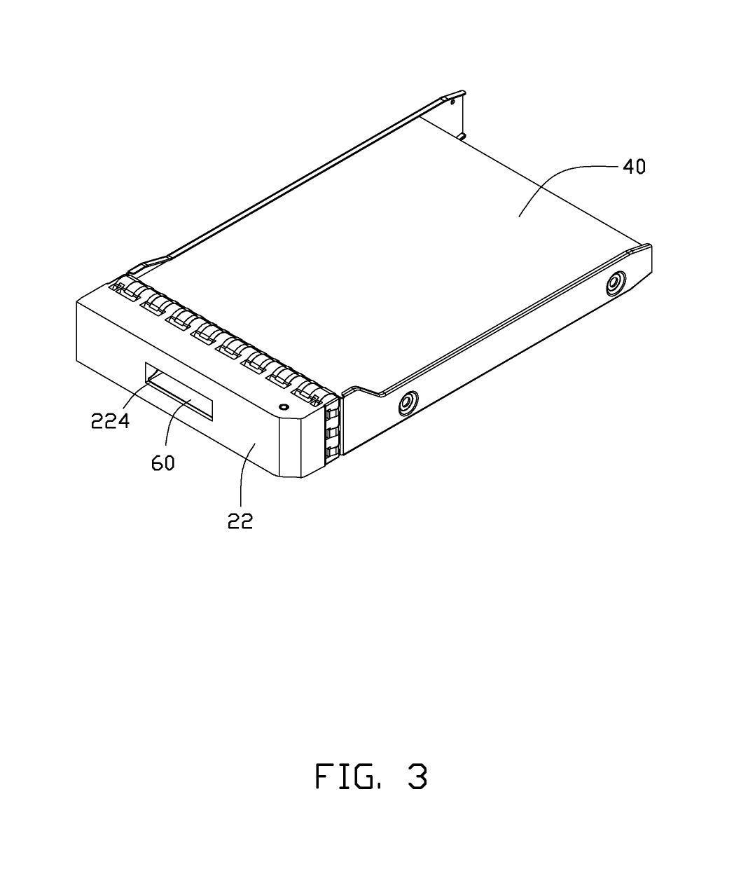

Referring to FIG. 3, in assembly, the front side of the shield member 60 is inserted into the opening 224 of the main body 22 from the receiving space 26, until the flange 66 abuts against a rear surface of the shield plate 222 opposite to the front wall 221, to install the shield member 60 to the main body 22. The hard disk drive 40 is received in the receiving space 26, and the bar code 412 is aligned with the through slot 65 of the shield member 60. A plurality of screws respectively extends through the through holes 240 of the arms 24, to be screwed into the screw holes 422 of the hard disk drive 40. Thereby, the bar code 412 is exposed through the through slot 65, and can be directly scanned by a scanner.

When the hard disk device 40 operates, heat and electromagnetic radiations are generated by the hard disk device 40. The heat is dissipated out of the bracket 20 through the through slot 65. Some of the electromagnetic radiation enters the through slot 65, and is repeatedly reflected between the side plates 62 and the end plates 64 thus preventing or educing the amount of electromagnetic radiation leaking out of the bracket 20.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A hard disk drive module, comprising:
a bracket comprising a main body defining an opening;
a hard disk drive received in the bracket, a bar code mounted on the hard disk drive; and
a shielding member made of electromagnetic interference shielding material, and received in the opening, the shielding member defining a through slot through which the bar code is exposed.

2. The hard disk drive module of claim 1, wherein the shielding member comprises two opposite side plates, and two opposite end plates connected between corresponding ends of the side plates, the side plates and the end plates cooperatively bound the through slot.

3. The hard disk drive module of claim 2, wherein a front side of each end plate defines a cutout.

4. The hard disk drive module of claim 2, wherein the bracket further comprises two arms respectively extending rearward from two opposite ends of the main body, the main body and the arms cooperatively bound a receiving space for receiving the hard disk drive.

5. The hard disk drive module of claim 4, wherein the main body comprises a front wall and shield plate sandwiched between the front wall and the arm, the opening is defined in the front wall and extends through the shield plate.

6. The hard disk drive module of claim 5, wherein a flange protrudes out from rear sides of the side plates and the end plates, and abuts against a rear surface of the shield plate opposite to the front wall.
